(19) United States
(12) Patent Application Publication
(10) Pub. No.: US 2008/0282485 A1
(43) Pub. Date: Nov. 20, 2008

(54) Navy Blue and Black Mixtures, Method for the Production Thereof, and Their Use for Dying Material Containing Hydroxy Groups

(75) Inventors: Gunther Widler, Grosskarlbach (DE); Erwin Lucic, Ludwigshafen (DE); Michael Krapp, Altrip (DE); Heiko Brunner, Berlin (DE); Gerhard Epple, Weisenheim/Berg (DE)

Correspondence Address: CONNOLLY BOVE LODGE & HUTZ, LLP, P O BOX 2207, WILMINGTON, DE, 19899, US

(73) Assignee: DYSTAR TEXTILFARBEN GMBH & Co. DEUTSCHLAND KG, Frankfurt am Main (DE)

(21) Appl. No.: 11/721,719

(22) PCT Filed: Dec. 13, 2005
(86) PCT No.: PCT/EP05/56741

§ 371 Date: Sep. 4, 2007

(30) Foreign Application Priority Data
Dec. 17, 2004 (DE) 10 2004 060 968.3

(51) Int. Cl. C09B 67/22; D06P 1/22

(52) U.S. Cl. 8/638

(57) ABSTRACT

Mixtures of vat dyes for hue-stable dyeings in navy to black shades comprising C.I . Vat Black 9 and at least one of C.I. Vat Blue 18, C.I. Vat Blue 19, C.I . Vat Blue 22, C.I. Vat Blue 6 and also halogenated 16,17-diethyidibenzanthrone derivatives, C.I. Vat Violet 13, C.I. Vat Black 20, and optionally C.I. Vat Black 65, processes for their production by mechanical mixing of the components and their use for hue-stable dyeing and printing of cellulosic material.

The present invention relates to mixtures of vat dyes for hue-stable dyeings with vat dyes in navy and black shades.

Commercially available navy and black mixtures of vat dyes have certain performance defects, for example a more or less pronounced shift in hue to redder on soaping in textile-dyeing and -finishing facilities and also at the consumer's. In addition, the abovementioned dyes demonstrate defective fastness to water spotting. This applies to the pure dyes as well as to their mixtures.

Consequently, there is need for novel vat dye mixtures for producing navy to black shades having improved hue stability on soaping and improved fastness to water spotting.

It has now been found that, surprisingly, dye mixtures comprising C.I. Vat Black 9 and at least one of C.I. Vat Blue 18, C.I. Vat Blue 19, C.I. Vat Blue 22, C.I. Vat Blue 6, halogenated 16,17-dialkyldibenzanthrone derivatives, C.I. Vat Violet 13, C.I. Vat Red 10, C.I. Vat Red 23, C.I. Vat Red 31, C.I. Vat Red 54, C.I. Vat Black 20 and optionally C.I. Vat Black 65 substantially meet the abovementioned requirements.

The invention accordingly provides mixtures of vat dyes for hue-stable dyeings in navy to black shades comprising C.I. Vat Black 9 and at least one of C.I. Vat Blue 18, C.I. Vat Blue 19, C.I. Vat Blue 22, C.I. Vat Blue 6 and also halogenated 16,17-dialkyl-dibenzanthrone derivatives, C.I. Vat Violet 13, C.I. Vat Red 10, C.I. Vat Red 23, C.I. Vat Red 31, C.I. Vat Red 54, C.I. Vat Black 20, and also optionally C.I. Vat Black 65. Preferred dye mixtures comprise C.I. Vat Blue 22, C.I. Vat Violet 13 and C.I. Vat Black 9.

The mixing ratios used may be between 40% to 99% by weight for the blue dyes used, between 0.5% to 40% by weight of the violet dye used and between 0.5% to 40% by weight of the black dye used.

Particularly preferred dye mixtures comprise 57% to 75% by weight of C.I. Vat Blue 22, 15% to 36% by weight of C.I. Vat Violet 13 and 8% to 20% by weight of C.I. Vat Black 9. Very particularly preferred dye mixtures comprise 66.4% by weight of C.I. Vat Blue 22, 15.3% by weight of C.I. Vat Violet 13 and 18.3% by weight of C.I. Vat Black 9.

The dye mixtures of the present invention can be a preparation in solid or liquid form. In solid form, they contain, to the extent necessary, the auxiliaries (for example dispersants, dustproofers) and shading dyes customary in commercial dyes; in liquid form (including a content of thickeners of the type customary in print pastes), they may also include substances which ensure a long life for these preparations, examples being mold preventatives.

In solid form, the dye mixtures according to the invention are generally present as electrolyte-salt containing powders or granules (hereinafter referred to in general as a preparation) with or without one or more of the abovementioned auxiliaries. In the preparations, the dye mixture is present at 20% to 90% by weight, based on the preparation containing it.

When the dye mixtures of the present invention are present in an aqueous solution, the total dye content in these aqueous solutions is up to about 50% by weight, for example between 5% and 50% by weight.

The dye mixtures of the present invention are producible in a conventional manner, for example by mechanically mixing the individual dyes, whether in the form of their dye powders or granules or their formulated liquid brands of the individual dyes, preferably in the presence of dispersants.

This mixing operation is advantageously carried out in suitable mills, for example ball or sand mills. But separately formulated individual dyes can also be mixed by stirring into dyeing liquors.

To establish or improve the degree of dispersity, a surface-active agent or a mixture of surface-active agents can be added. It will be appreciated that the size of the dye particles can also be appropriately influenced and set to a desired value by a grinding treatment, for example wet bead milling, whether during the synthesis or else immediately thereafter.

Useful dispersants include anionic or nonionic dispersants. As well as dispersants from one or other group, it is also possible to use dispersant mixtures, in which case mixtures of nonionic and anionic dispersants are primarily intended, since anionic and cationic dispersants tend to form precipitates when mixed with one another.

Useful anionic dispersants are in particular condensation products of aromatic sulfonic acids with formaldehyde, such as condensation products of formaldehyde and alkylnaphthalenesulfonic acids or of formaldehyde, naphthalenesulfonic acids and benzenesulfonic acid, condensation products of substituted or unsubstituted phenol with formaldehyde and sodium bisulfite.

It is further possible to use in particular ligninsulfonates, for example those obtained by the sulfite or kraft process, Preferably they are products which are partly hydrolyzed, oxidized, propoxylated or desulfonated and fractionated according to known methods, for example according to the molecular weight or the degree of sulfonation. Mixtures of sulfite and kraft ligninsulfonates are likewise very effective,

Particular utility is possessed by ligninsulfonates having an average molecular weight between 1000 and 100 000, an active ligninsulfonate content of not less than 80% and preferably a low polyvalent cation content. The degree of sulfonation can vary within wide limits.

Useful nonionic dispersants or emulsifiers include for example reaction products of alkylene oxides with alkylatable compounds, for example fatty alcohols, fatty amines, fatty acids, phenols, alkyiphenols, arylalkylphenols and carboxamides.

These are for example ethylene oxide adducts from the class of the reaction products of ethylene oxide with
a) saturated and/or unsaturated fatty alcohols having 6 to 20 carbon atoms; or
b) alkylphenols having 4 to 12 carbon atoms in the alkyl radical, or
c) saturated and/or unsaturated fatty amines having 14 to 20 carbon atoms;
d) saturated and/or unsaturated fatty acids having 14 to 20 carbon atoms.

Useful ethylene oxide adducts include
a) reaction products of saturated and/or unsaturated fatty alcohols having 6 to 20 carbon atoms with 5 to 30 mol of ethylene oxide,
b) reaction products of alkylphenols having 4 to 12 carbon atoms with 5 to 20 mol of ethylene oxide;
c) reaction products of saturated and/or unsaturated fatty amines having 14 to 20 carbon atoms with 5 to 20 mol of ethylene oxide;
d) reaction products of saturated and/or unsaturated fatty acids having 14 to 20 carbon atoms with 5 to 20 mol of ethylene oxide.

The dye mixtures of the present invention, both as such or else mixed with other vat dyes, are very useful for dyeing and printing cellulosic fibrous materials.

The dye mixtures of the present invention should be present in a very fine state of subdivision in the dyeing liquors used in the above applications. The dyes are finely divided in a conventional manner by dispersing the dye mixtures in a liquid medium, preferably in water, together with dispersants and exposing the mixture to the action of shearing forces, the dye fragments originally present being mechanically comminuted to such an extent that an optimum specific surface area is achieved and the sedimentation of the dye is kept to a minimum. The particle sizes of the dyes are generally between 0.5 and 5 μm, preferably they are about 1 μm.

The dye dispersions thus obtained may additionally comprise further auxiliaries, examples being fungicides and drying preventatives.

Pulverulent and granular brands are preferred for most fields of application. They comprise the dye, dispersants and other auxiliaries, such as defoamers and dustproofers for example.

A preferred process for producing pulverulent dye formulations consists in the above-described liquid dye dispersions being stripped of their liquid, for example by vacuum drying, freeze drying, by drying on drum dryers, but preferably by spray drying.

The dye mixtures of the present invention may be individually formulated and, after individual formulation, be mixed in liquid-disperse form and finished as a liquid dye formulation or, after mixing of the liquid-disperse form, be dried or mixed after drying the individual components. Drying is here to be understood as referring to the common prior art processes such as vacuum drying, drum drying, spray drying, granulation or freeze drying. To establish or improve the degree of dispersion, a surface-active agent or a mixture of surface-active agents can be added. It will be appreciated that the size of the dye particles can also be appropriately influenced and set to a desired value by a grinding treatment, for example wet bead milling, whether during the synthesis or else immediately thereafter.

A possible procedure for producing the present invention's dye mixtures in finely divided form is as follows.

For example, 10 to 50 parts by weight of inventive dye mixture are bead milled with
0 to 90 parts by weight of ligninsulfonate,
90 to 0 parts by weight of condensation product of naphthalenesulfonic acids and formaldehyde,
0 to 10 parts by weight of nonionic surfactant,
0 to 2 parts by weight of wetting agent,
0 to 2 parts by weight of defoamer,
0 to 3 parts by weight of dustproofer.

The dye mixtures of the present invention can be applied for dyeing purposes not only by means of classic chemical reducing agents (inorganic reducing agents (for example sulfidic reducing agents), organic reducing agents, for example hydroxyacetone) but also electrochemically, and are useable in all dyeing processes customary for that dye, for example in the exhaust process or in the pad steam process

Table 1 shows the color properties in soaping of the dyes of the present invention compared with conventional navy brands.

The dyeing was assessed colorimetrically by color locus measurement in accordance with German standard specifications DIN 6174 and DIN 5033. Examples 1 and 2 show the color data with regard to the soaping of existing commercial dyes, while Examples 3 to 6 show the color profile of the navy mixtures of the present invention.

TABLE 1
Color data in soaping of inventive mixtures

| | | Color differences | | | | | |
|---|---|---|---|---|---|---|---|
| | | dH | | | dC | | |
| | | minutes | | | minutes | | |
| Example No. | Dye composition | 0 vs 1 | 0 vs 20 | 1 vs 20 | 0 vs 1 | 0 vs 20 | 1 vs 20 |
| 1 Prior art | 8% C.I. Vat Blue 22 | 0.3 | 0.5 | 0.2 | −1.5 | 0.3 | 1.8 |
| 2. Prior art | 4% mix consisting of 37.6% C.I. Vat Blue 20, 43.1% C.I. Vat Blue 4 and | 1.4 | 3.8 | 2.4 | 1.2 | 1.2 | 0 |
| | 19.3% C.I. Vat Green 3 | | | | | | |
| 3: Sample 1 | 8% sample 1: 40% C.I. Vat Blue 22; 40% C.I. Vat Violet 13; 18.6% C.I. Vat | 0.5 | 0.6 | 0.1 | 0.4 | 0.5 | 0.1 |
| | Black 9; | | | | | | |
| 4: Sample 2 | 5.6% sample 2: 57.1% C.I. Vat Blue 22; 28.6% C.I. Vat Violet 13; 13.34% | 0.4 | 0.6 | 0.2 | 0.4 | −0.1 | −0.5 |
| | C.I. Vat Black 9; | | | | | | |
| 5: Sample 3 | 4% sample 3: 66.3% C.I. Vat Blue 22; 15.3% C.I. Vat Violet 13; 17.20% C.I. | 0.1. | 0 | −0.1 | 0.2 | 0.3 | 0.1 |
| | Vat Black 9; 1.2% | | | | | | |
| | 4.425% sample 4: 74.6% C.I. Vat Blue 22; 16.9% Vat Violet 13; 2.65% C.I. | | | | | | |
| | Vat Black 9; 5.65% | | | | | | |
| 6: Sample 4 | C.I. Vat Black 65; | 0.3 | 0.6 | 0.3 | 0.4 | 0 | 0.4 |
| 7: Sample 5 | 3.62% sample 5: 71.82% C.I. Vat Blue 22, 19.88% C.I. Vat Black 9; 8.3% | 0.6 | 0.9 | 0.3 | 0.9 | 1.2 | 0.3 |
| | C.I. Vat Red 10 | | | | | | |
| 8: Sample 6 | 3.62% sample 6: 71.82% C.I. Vat Blue 22; 19.88% C.I. Vat Black 9; 8.3% | −0.2 | −0.6 | −0.4 | 0 | −0.8 | −0.8 |
| | C.I. Vat Red 23 | | | | | | |

As the dH and dC values in Table 1 show, the novel inventive dye mixtures (Examples 3 to 6) demonstrate high stability especially with regard to hue and cleanness.

The examples which follow serve to illustrate the invention.

### Production of Dye Mixture

Sample 1

A suitable mixer is used to mix 102.4 g of finished C.I. Vat Blue 22 liquid (dye content: 40%), 102.4 g of finished C.I. Vat Violet 13 liquid (dye content: 40%) and 51.2 g of finished C.I. Vat Black 9 liquid (dye content: 40%) for 3 hours.

256 g of dye mixture consisting of
40% by weight of C.I. Vat Blue 22
40% by weight of C.I. Vat Violet 13
18.66% by weight of 0.1. Vat Black 9 are obtained.

Sample 2

A suitable mixer is used to mix 150.7 g of finished C.I. Vat Blue 22 liquid (dye content: 40%), 75.4 g of finished C.I. Vat Violet 13 liquid (dye content: 40%) and 37.7 g of finished C.I. Vat Black 9 liquid (dye content: 40%) for 3 hours similarly to Example 5.

264 g of dye mixture consisting of
57% by weight of C.I. Vat Blue 22
28.6% by weight of C.I. Vat Violet 13
13.34% by weight of C.I. Vat Black 9 are obtained.

Sample 3

A suitable mixer is used to mix 252 g of finished C.I. Vat Blue 22 liquid (dye content: 40%), 58 g of finished C.I. Vat Violet 13 liquid (dye content: 40%) and 70 g of finished C.I. Vat Black 9 liquid (dye content: 40%) for 1 hour.

380 g of dye mixture consisting of
66.3% by weight of C.I. Vat Blue 22
15.3% by weight of C.I. Vat Violet 13
17.2% by weight of C.I. Vat Black 9 are obtained.

Sample 4

A suitable mixer is used to mix 283.5 g of finished C.I. Vat Blue 22 liquid (dye content. 40%), 64.2 g of finished C.I. Vat Violet 13 liquid (dye content: 40%), 10.7 g of finished C.I. Vat Black 9 (dye content: 40%) and 21.6 g of finished C.I. Vat Black 65 (dye content: 40%) for one hour.

380 g of dye mixture consisting of
74.6% by weight of C.I. Vat Blue 22
16.9% by weight of C.I. Vat Violet 13
2.65% by weight of C.I. Vat Black 9
5.65% by weight of C.I. Vat Black 65 are obtained.

Sample 5

A suitable mixer is used to mix 272.92 g of finished C.I. Vat Blue 22 liquid (dye content: 40%), 31.54 g of finished C.I. Vat Red 10 liquid (dye content. 40%), 75.54 g of finished C.I. Vat Black 9 (dye content: 40%) for one hour.

380 g of dye mixture consisting of
71.82% by weight of C.I. Vat Blue 22
8.3% by weight of C.I. Vat Red 10
19.88% by weight of C.I. Vat Black 9 are obtained.

Sample 6

A suitable mixer is used to mix 272.92 g of finished C.I. Vat Blue 22 liquid (dye content: 40%), 31.54 g of finished C.I. Vat Red 23 liquid (dye content: 40%) and 75.54 g of finished C.I. Vat Black 9 (dye content: 40%) for one hour.

380 g of dye mixture consisting of
71.82% by weight of C.I. Vat Blue 22
8.3% by weight of C.I. Vat Red 23
19.88% by weight of C.I. Vat Black 9 are obtained.

Illustration Dyeing

A dyeing liquor which consists of 10% (based on the weight of the cotton knit fabric to be dyed) of the mixed dye of Samples 1 to 6, 35 ml/l of 38° Bé caustic soda and 12 g/l of sodium dithionite 85% as reducing agent is prepared together with the fabric to be dyed, in this case cotton knit fabric, at room temperature in a liquor ratio of 20 parts of water to 1 part of goods. The dyeing vessel is sealed and heated to 60° C. at 2° C./min. It is then kept at 60° C. for 45 min. During this time, the dye dissolved by the reducing agent goes onto the fiber. This is followed by rinsing with cold water and then the oxidation. To this end, a treatment liquor containing 2 ml/l of hydrogen peroxide 50% is prepared at 60° C. in a liquor ratio of 50:1. The oxidation is carried out at these conditions for 10 min. The soaping step which takes place subsequently is used to establish the final hue for the dyeing. For this, a treatment liquor containing 1 g/l of a commercially available soaping agent and 0.5 g/l of sodium carbonate is prepared at 98° C. in a liquor ratio of 50:1. This treatment is carried out for 20 min. This is followed by rinsing, dewatering and drying.

1-6. (canceled)

7. A mixture of vat dyes for hue-stable dyeings in navy to black shades comprising C.I. Vat Black 9 and
at least one of C.I. Vat Blue 18, C.I. Vat Blue 19, C.I. Vat Blue 22, C.I. Vat Blue 6 and halogenated 16,17-dialkyldibenzanthrone derivatives, C.I. Vat Violet 13, C.I. Vat Red 10, C.I. Vat Red 23, C.I. Vat Red 31, C.I. Vat Red 54, C.I. Vat Black 20, and 10/6 optionally C.I. Vat Black 65.

8. The navy mixture according to claim 7, which comprise
0.5% to 40% by weight of Cl Vat Black 9,
40% to 99% by weight of C.I. Vat Blue 22 and
0.5% to 40% by weight of C.I. Vat Violet 13.

9. The navy mixture according to claim 7, which comprise
66.4% by weight of C.I. Vat Blue 22,
15.3% by weight of C.I. Vat Violet 13 and
18.3% by weight of C.I. Vat Black 9.

10. A process for producing a dye mixture according to claim 7 which comprises mechanical mixing of the components.

11. Dye and pigment preparations comprising the dye mixture according to claim 7,

12. A process of hue-stable dying a material which comprises contacting the material with the dye mixture according to claim 7.

13. A process for printing of cellulosic material which comprises contacting the material with the dye mixture according to claim 7.
